(19) United States
(12) Patent Application Publication
(10) Pub. No.: US 2013/0177830 A1
(43) Pub. Date: Jul. 11, 2013

(54) FUEL CELL ASSEMBLY SEALING ARRANGEMENT

(71) Applicants: Jason B. Parsons, Manchester, CT (US); Timothy W. Patterson, West Hartford, CT (US); Michael D. Harrington, West Hartford, CT (US); Christopher John Carnevale, Vernon, CT (US)

(72) Inventors: Jason B. Parsons, Manchester, CT (US); Timothy W. Patterson, West Hartford, CT (US); Michael D. Harrington, West Hartford, CT (US); Christopher John Carnevale, Vernon, CT (US)

(21) Appl. No.: 13/825,995

(22) PCT Filed: Oct. 29, 2010
(86) PCT No.: PCT/US10/54621

§ 371 Date: Mar. 26, 2013

(51) Int. Cl. H01M 8/24; H01M 8/02

(52) U.S. Cl. CPC H01M 8/2485; H01M 8/0276
USPC 429/460; 277/628; 277/312

(57) ABSTRACT

An example seal assembly includes a first seal that is configured to be placed between a fuel cell manifold and a fuel cell stack. The first seal establishes a recessed area within a side of the first seal that faces the fuel cell stack. The fuel cell seal assembly further includes a second seal that is configured to be placed between the first seal and the fuel cell stack within the recessed area. An example method of sealing a fuel cell interface includes holding a first seal within a groove established within a manifold and holding a second seal within a recessed area established within the second seal. The method limits flow of a fuel cell fluid using a first seal and the second seal.

### CROSS-REFERENCE TO RELATED APPLICATIONS

This application is the U.S. national phase of PCT/US2010/054621, filed Oct. 29, 2010.

### TECHNICAL FIELD

This disclosure relates generally to fuel cells. More particularly, this disclosure relates to a sealing arrangement for a fuel cell assembly.

### DESCRIPTION OF RELATED ART

Fuel cell stack assemblies (CSAs) are well known and typically include multiple individual fuel cells. The fuel cells include a polymer electrolyte membrane (PEM) positioned between porous carbon electrodes containing a platinum catalyst, which together establish a unitized electrode assembly. One of the electrodes operates as an anode while the other operates as a cathode. The individual fuel cells further include bipolar plates arranged adjacent each of the porous carbon electrodes. The fuel cells utilize fuel and oxidant, such as hydrogen and air, to generate electrical energy in a known manner. The fuel cells may also generate liquid and thermal byproducts. Manifolds are typically utilized to communicate fuel and oxidant to the fuel cells within the CSA. Other manifolds may be utilized to communicate byproducts away from the fuel cell.

Seal arrangements are used to block flow through a manifold's interfaces with the CSA. As the interfaces may include irregular surfaces, silicone-based seals are typically used. The pliability of the silicone seals facilitates accommodating the irregular surfaces.

### SUMMARY

An example seal assembly includes a first seal that is configured to be placed between a fuel cell manifold and a fuel cell stack. The first seal establishes a recessed area within a side of the first seal that faces the fuel cell stack. The fuel cell seal assembly further includes a second seal that is configured to be placed between the first seal and the fuel cell stack within the recessed area.

An example fuel cell stack assembly sealing arrangement includes a fuel cell stack having a plurality of outwardly facing surfaces. A manifold and one of the outwardly facing surfaces establish a portion of a fluid communication path. A nonsilicone seal arrangement is held between the outwardly facing surface and the manifold. The nonsilicone seal is configured to seal an interface between the outwardly facing surface and the manifold.

An example method of sealing a fuel cell interface includes holding a first seal within a groove established within a manifold and holding a second seal within a recessed area established within the second seal. The method limits flow of a fuel cell fluid using a first seal and the second seal.

These and other features of the disclosed examples can be best understood from the following specification and drawings. The following is a brief description of the drawings.

### BRIEF DESCRIPTION OF THE DRAWINGS

FIG. 1 shows a schematic view an example fuel cell assembly.

FIG. 2 shows an end view of the FIG. 1 fuel cell assembly.

FIG. 3 shows a close up view of a manifold interface in the FIG. 1 fuel cell assembly.

FIG. 4 shows an exploded view of the manifold and seal assembly of the FIG. 1 fuel cell assembly.

FIG. 5 shows the flow of an example method of sealing an interface within the FIG. 1 fuel cell assembly.

### DETAILED DESCRIPTION

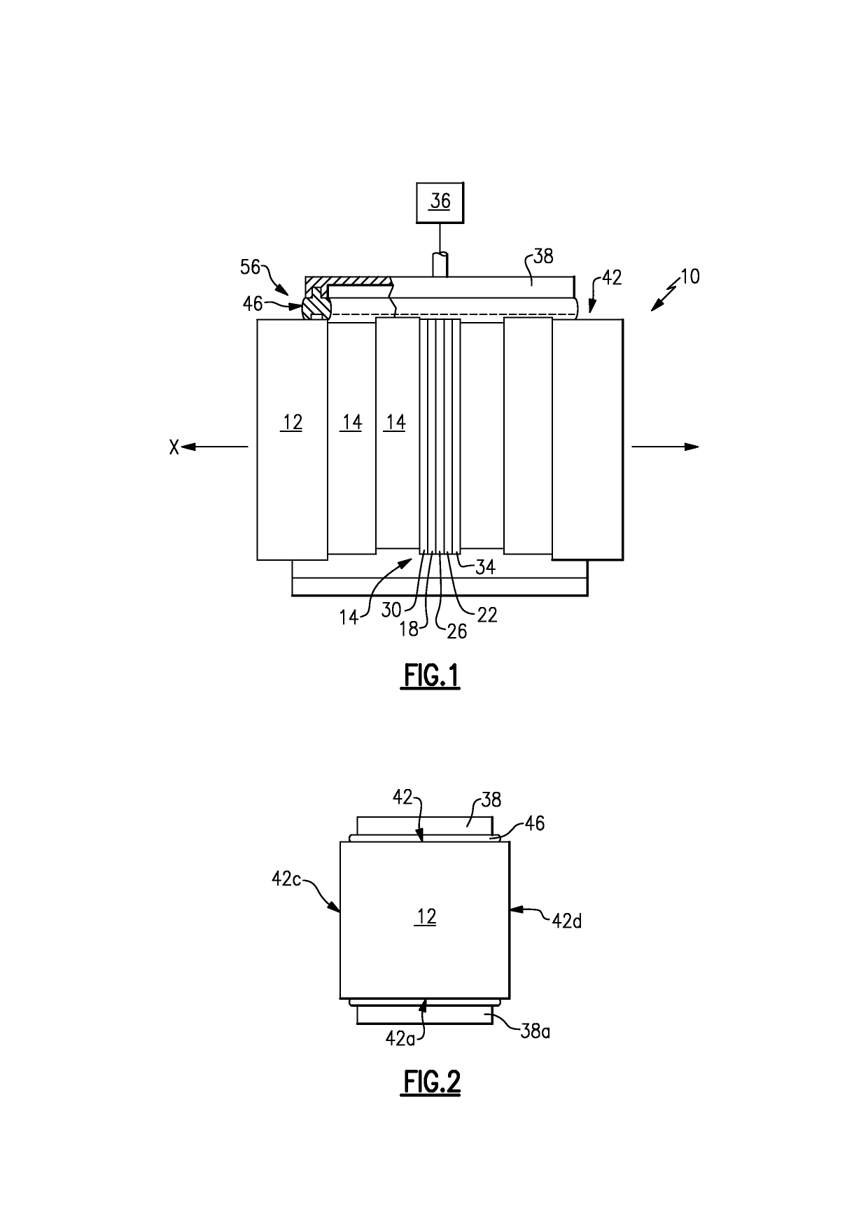

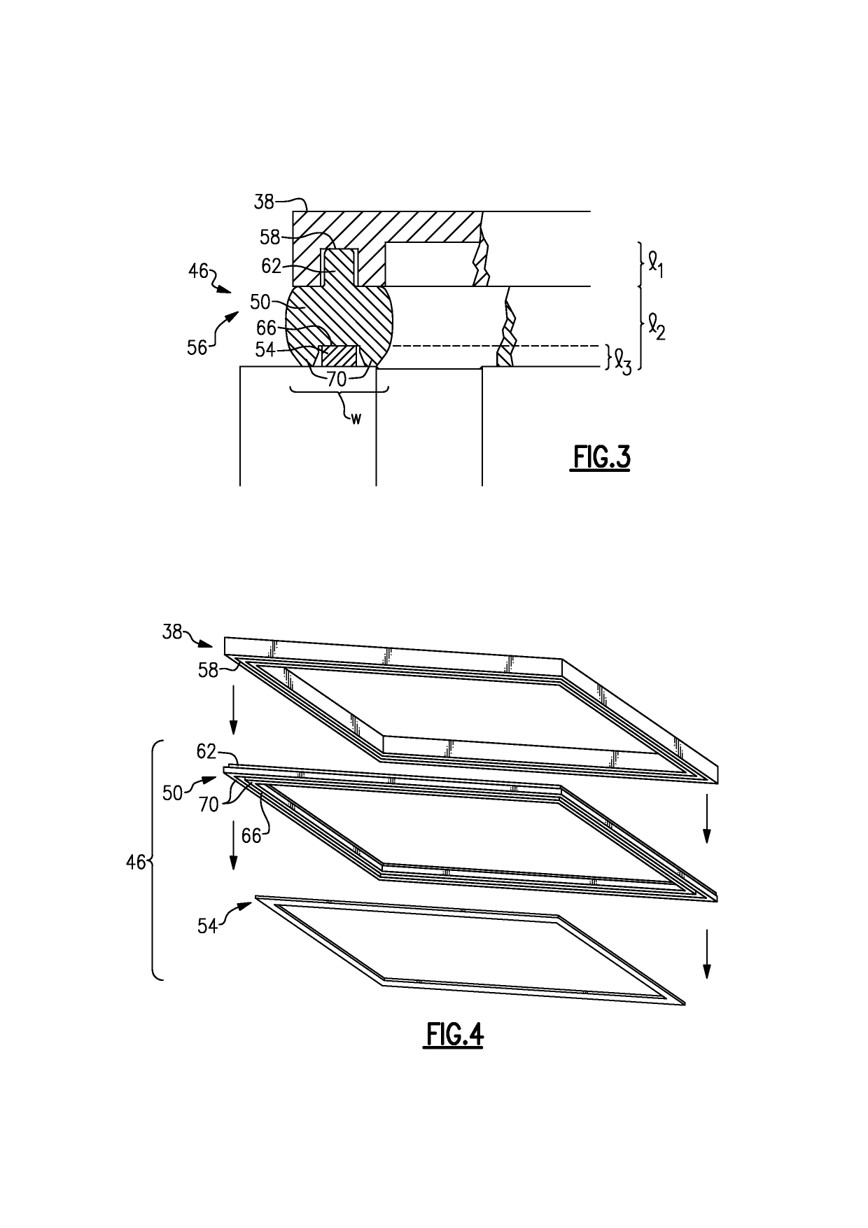

Referring to FIGS. 1 and 2, an example proton exchange membrane fuel cell stack assembly 10 includes pressure plates 12 configured to hold together multiple individual fuel cells 14 arranged in a stack. Each of the fuel cells 14 includes an anode 18 and a cathode 22 on opposing sides of a unitized electrode assembly 26. A flow field plate 30 is positioned near the anode 18. Another flow field plate 34 is positioned near the cathode 22. The unitized electrode assembly 26 includes a proton exchange membrane positioned between electrodes, as is known.

In this example, a fluid source 36 supplies a fuel cell fluid, such as hydrogen, to a manifold 38, which distributes the fluid to the fuel cell stack assembly 10 through the flow field plates 30 and 34.

The example manifold 38 is secured to an outwardly facing surface 42 of the fuel cell stack assembly 10. Another manifold 38a is secured to an outwardly facing surface 42a. Other examples include manifolds (not shown) on the outwardly facing surfaces 42a and 42b. The manifolds 38 and 38a are held against the outwardly facing surfaces 42 and 42a respectively with a steel cable and turnbuckle system. Other examples hold the manifolds 38 and 38a with other types of cables, bolts, latches, straps, or tie rods. As is known, the manifolds 38 and 38a communicate fuel cell fluids, such as the hydrogen from the fluid source 36 or an oxidant, to the fuel cells 14 or away from the fuel cells 14.

Although the example embodiment is described as sealing an interface between the manifold 38 and a proton exchange membrane fuel cell stack assembly 10, those skilled in the art and having the benefit of this disclosure will understand other types of fuel cells that would benefit from the disclosed embodiment.

In this example, the manifold 38 extends from one of the pressure plates 12 to another pressure plate 12. In another example, the manifold 38 extends across a smaller portion of the outwardly facing surface 42, such as from one of the pressure plates 12 to one of the fuel cells 14. More than one manifold 38 is arranged on the outwardly facing surface 42 in some examples.

The positions of the fuel cells 14 and their respective components can vary relative to a longitudinal axis X of the fuel cell stack assembly 10. As can be appreciated, these variances introduce irregularities in the outwardly facing surface 42 of the fuel cell stack assembly 10. A seal assembly 46 facilitates accommodating these irregularities.

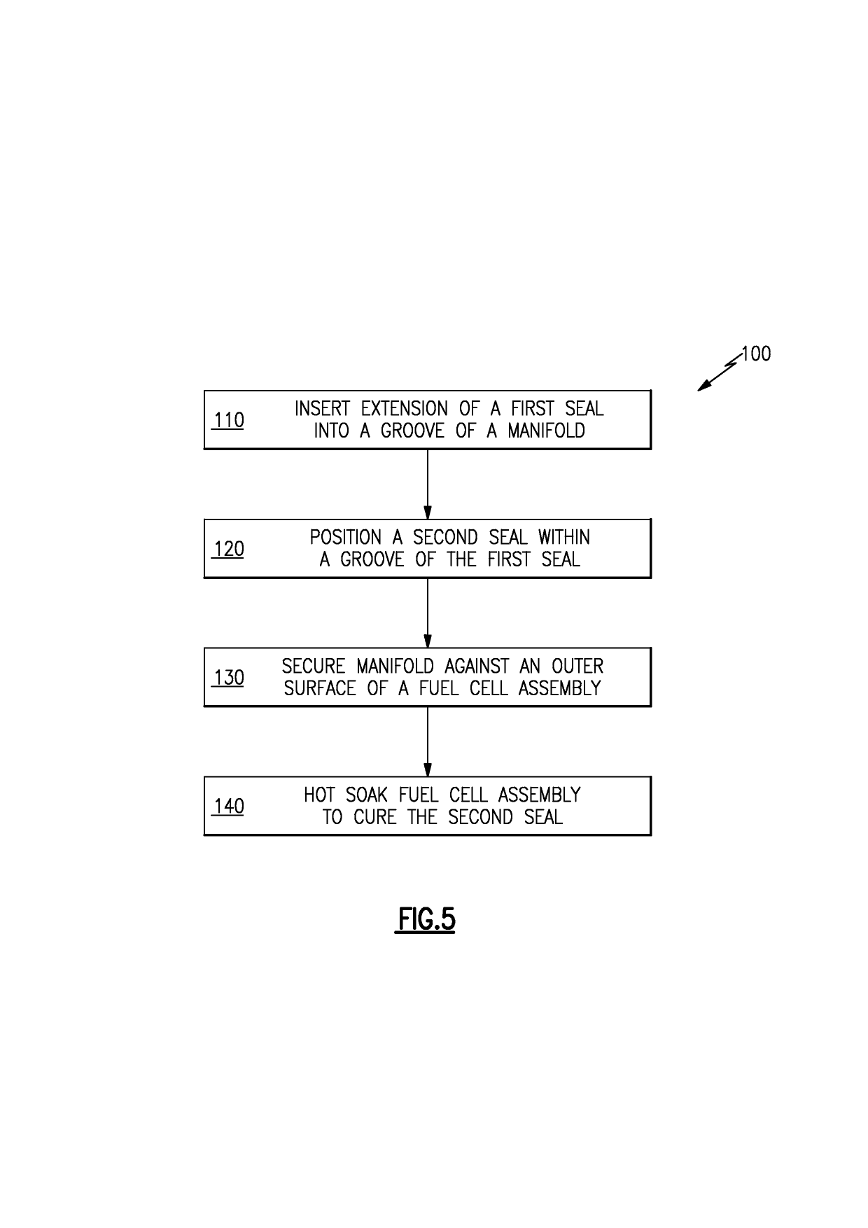

Referring now to FIGS. 3 and 4 with continuing reference to FIG. 1, the example seal assembly 46 includes a first seal 50 and a second seal 54 at an interface 56 between the manifold 38 and the fuel cell stack assembly 10. The manifold 38 establishes a groove 58 that receives an extension 62 of the first seal 50. The first seal 50 establishes a recessed area 66 that receives the second seal 54. As can be appreciated, the seal assembly 46 has a picture frame type configuration.

In this example, the first seal 50 includes a plurality of ridges 70 that extend away from the extension 62. The plurality of ridges 70 establish the recessed area 66. The plurality of ridges 70 are configured to contact the pressure plates 12 of the fuel cell stack assembly 10 when the manifold 38 is held against the outwardly facing surface 42. As can be appreciated, the plurality of ridges 70 and the second seal 54 both contact a peripheral portion of the outwardly facing surface 42. In another example, the plurality of ridges 70 and the second seal 54 contact other areas of the outwardly facing surface 42, such as when the manifold 38 covers a smaller portion of the outwardly facing surface 42.

The extension 62 of the example first seal 50 has a length l₁ ranging from 5.7 mm and 6.2 mm. A main body portion of the example first seal 50 has a length l₂ of 9.1 mm. Each of the plurality of ridges 70 have a length l₃ of 1.1 mm, and the width w of the example first seal 50 is about 8 mm.

The example first seal 50 is somewhat pliable, which facilitates an initial interference fit, or friction fit, between the first seal 50 and the manifold 38 before the manifold 38 is secured relative to the outwardly facing surface 42. The example first seal 50 is thus considered a press-in-place seal. Other examples initially secure the first seal 50 relative to the manifold 38 using other techniques, such as an adhesive.

In this example, both the first seal 50 and the second seal 54 are nonsilicone seals. Specifically, the example first seal 50 comprises an ethylene propylene diene Monomer (EPDM) rubber, and the example second seal 54 comprises a fluoroelastomer (FKM) material. Dyneon™ manufactures a material suitable for the second seal 54 in one example.

The example second seal 54 is a sealant tape having a rectangular cross-section before the second seal 54 is heat cured. In another example, the second seal 54 is a dispensable sealant that is dispensed from a tube directly into the recessed area 66.

When the second seal 54 is initially secured against the outwardly facing surface 42, the second seal 54 is pliable and conforms to the irregularities in the outwardly facing surface 42. That is, the cross-section of the second seal 54 changes from having a consistent rectangular cross-section to having an irregular cross-section that accommodates the irregularities in the outwardly facing surface 42. Pressure exerted by the manifold 38 helps conform the second seal 54 to irregularities in the outwardly facing surface 42. Curing the second seal 54 then stabilizes the shape of the second seal 54 and enables the second seal 54 to seal a portion of the interface 56.

The plurality of ridges 70 limit movement or rolling of the second seal 54 during the curing process. Notably, the plurality of ridges 70 also conform somewhat to the irregularities in the outwardly facing surface 42, but, due to the material characteristics of the first seal 50, do not typically provide a consistently sealed interface.

Referring to FIG. 5 with continuing reference to FIGS. 3 and 4, an example method 100 of installing the seal assembly 46 includes inserting the extension 62 of the first seal 50 within the groove 58 at a step 110. The step 110 secures the first seal 50 relative to the manifold 38.

Next, at a step 120, the second seal 54 is positioned within the recessed area 66 of the first seal 50. Adhesive is used to secure the second seal 54 within the recessed area 66, for example. In another example, material properties of the first seal 50 and the second seal 54 are relied on to secure the second seal 54 within the recessed area 66.

The manifold 38 is then secured relative to the outwardly facing surface 42 at a step 130. In one example, the manifold 38 is pressed against the outwardly facing surface 42 such that the second seal 54 is entombed within the recessed area 66 of the first seal 50, and both the first seal 50 and the second seal 54 contact the outwardly facing surface 42.

At a step 140, the fuel cell stack assembly 10 is hot soaked. The hot soak cures the second seal 54 to seal the interface 56. In this example, the second seal 54 cures within four hours when the fuel cell stack assembly 10 is hot soaked at 80° C.

Features of the disclosed example include a simplified sealing arrangement that conforms to irregularities in a fuel cell stack's outwardly facing surface. Another feature is reducing a tendency for seal rolling.

The preceding description is exemplary rather than limiting in nature. A person of ordinary skill in this art may recognize certain variations and modifications to the disclosed examples that do not depart from the essence of this disclosure. For that reason, the following claims should be studied to determine the true scope of legal protection given to this disclosure.

We claim:

1. A seal assembly, comprising:
a first seal that is configured to be placed between a fuel cell manifold and a fuel cell stack, the first seal establishing a recessed area within a side of the first seal that faces the fuel cell stack; and
a second seal that is configured to be placed between the first seal and the fuel cell stack within the recessed area.

2. The seal assembly of claim 1, wherein the first seal comprises an ethylene propylene diene Monomer rubber.

3. The seal assembly of claim 1, wherein the second seal comprises a fluoroelastomer seal.

4. The seal assembly of claim 3, wherein the second seal comprises a Dyneon™.

5. The seal assembly of claim 1, wherein the second seal comprises a heat cured seal.

6. The seal assembly of claim 1, wherein the first seal and the second seal contact the fuel cell stack.

7. The seal assembly of claim 1, wherein at least a portion of a side of the first seal that faces the manifold is received within a groove established by the manifold.

8. The seal assembly of claim 1, wherein the first seal comprises an extension configured to be received within a groove established by the manifold, and the first seal comprises a plurality of ridges extending away from the extension, the plurality of ridges configured to establish at least a portion of a recessed area that holds the second seal, the plurality of ridges further configured to contact the fuel cell stack.

9. The seal assembly of claim 1, wherein the fuel cell stack comprises an outwardly facing surface, the second seal configured to seal against a periphery of the outwardly facing surface.

10. A fuel cell assembly sealing arrangement, comprising:
a fuel cell stack having a plurality of outwardly facing surfaces;
a manifold and at least one of the outwardly facing surfaces establishing a fluid communication path; and
a nonsilicone seal arrangement held between the at least one outwardly facing surface and the manifold, the nonsilicone seal configured to seal an interface between the at least one outwardly facing surface and the manifold.

11. The sealing arrangement of claim 10, wherein a peripheral portion of the manifold establishes a portion of the interface.

12. The sealing arrangement of claim 10, wherein the fluid communication path is configured to communicate a fuel, oxidant, or both, to the fuel cell stack.

13. The sealing arrangement of claim 10, wherein the nonsilicone seal comprises a first seal having a portion received within a groove of the manifold and a second seal having a portion received within a recessed area of the first seal.

14. The sealing arrangement of claim 13, wherein the first seal and the second seal contact the at least one outwardly facing surface.

15. The sealing arrangement of claim 13, wherein the fuel cell stack comprises a portion of a proton exchange membrane fuel cell.

16. A method of sealing a fuel cell interface, comprising:
holding a first seal within a groove established within a manifold;
holding a second seal within a groove established within the second seal; and
limiting flow of a fuel cell fluid using a first seal and the second seal.

17. The method of claim 16, including holding the first seal and the second seal against an outwardly facing surface of a fuel cell stack.

18. The method of claim 16, including encapsulating the second seal between the first seal and an outwardly facing surface of a fuel cell stack.

19. The method of claim 16, wherein the first seal and the second seal are nonsilicone seals.

20. The method of claim 16, including curing the second seal when hot-soaking a fuel cell.
